(19) United States
(12) Patent Application Publication
(10) Pub. No.: US 2004/0021667 A1
(43) Pub. Date: Feb. 5, 2004

(54) Program, recording medium, three-dimensional grouped character controlling method and game apparatus

(75) Inventor: Jumpei Tsuda, Kawasaki-shi (JP)

Correspondence Address: NIXON PEABODY, LLP, 401 9TH STREET, NW, SUITE 900, WASINGTON, DC, 20004-2128, US

(73) Assignee: KOEI CO, LTD., Yokohama-shi (JP)

(21) Appl. No.: 10/386,561

(22) Filed: Mar. 13, 2003

(30) Foreign Application Priority Data
Jul. 30, 2002 (JP) 2002-221977

(51) Int. Cl. G06T 15/70

(52) U.S. Cl. 345/474

(57) ABSTRACT

A program which can control a movement of grouped characters which move in a three-dimensional virtual space with a reality and great interest is provided. A three-dimensional polygon model is prepared, and each agent character is imparted an acceleration as kinematical performance where a force is obtained by multiplying a predetermined constant and a position vector together so as to follow each vertex of the polygon model (steps 208 and 210). Thereby, a group form of the agent characters having some fluctuation and a chaotic group form of the agent characters having some tendency are realized at the same time. A state that the group of the agent characters moves as if they were one creature as a whole is rendered by imparting a motion to the polygon model that the agent characters follow.

### FIELD OF THE INVENTION

The present invention relates to a program, a recording medium, a three-dimensional group controlling method and a game apparatus, and more particular to a program, a recording medium, a three-dimensional group controlling method and a game apparatus for controlling a movement of a group which is formed by a large number of characters in a three-dimensional virtual space.

### DESCRIPTION OF THE RELATED ART

Recently, because a computer hardware technique has been rapidly developed, a game which is executed by a video game apparatus for home use or by a computer displays images having high quality such as a movie on a display. Accordingly, it is required to render characters and the like more real on the display. Further, the number of the characters rendered in a three-dimensional virtual space is showing a tendency to increase with the progress of a computer in a processing speed, and a rendering technique for moving a group of the characters is being improved variously so as to obtain a reality.

Japanese Patent Application No. 2000-266717 discloses a technique for controlling a movement of grouped characters where a large number of characters form a simple formation (battle formation) such as a triangle or the like. According to the technique, a state where a large number of characters such as cavalries or the like move (on the ground) two-dimensionally as a group can be rendered.

Further, an animated cartoon or the like which expresses a group being formed by a large number of characters (eg. fish or the like) three-dimensionally is known conventionally. Moreover, in some graphic creating tool for a high-end computer, a motion simulation of a moving object (eg. a vehicle, an airplane) having a direction can be rendered by utilizing motion equations (Euler's motion equations) regarding a rigid body.

However, when a game apparatus controls a movement of a large number of characters as a group in the three-dimensional virtual space, conventional animation and CG techniques can not be applied as they are. Furthermore, in a case of rendering a movement of the moving object having a direction, when the motion equations regarding a rigid body is solved, fine time steps are required at a stage of solving a differential equation. Accordingly, a computation burden becomes heavy and, it involves mathematically difficult ideas for operating a calculation of an inertial tensor, an instantaneous coordinate system and the like. Therefore, in view of the present performance, the game apparatus is not suitable for processing a movement of hundreds of moving objects in a real time (eg. for each 1/60 second).

### SUMMARY OF THE INVENTION

In view of the above circumstances, an object of the present invention is to provide a program, a recording medium, a three-dimensional group controlling method and a game apparatus which can control a movement of grouped characters which move in a three-dimensional virtual space with a reality and great interest.

In order to achieve the above object, according to a first aspect of the present invention, there is provided a program for controlling a movement of a group which is formed by a large number of characters in a three-dimensional virtual space, wherein a computer is caused to function as: a model data imparter for imparting motion data of an invisible three-dimensional polygon model which operates in the three-dimensional virtual space; a kinematical performance imparter for imparting kinematical performance to each character which is associated with each vertex of the three-dimensional polygon model so as to follow the vertex; and a position calculator for calculating a position of the character in the three-dimensional virtual space.

According to the first aspect, the motion data of the invisible three-dimensional polygon model which operates in the three-dimensional virtual space are imparted by the model data imparter, the kinematical performance to each character which is associated with each vertex of the three-dimensional polygon model so as to follow the vertex is imparted by the kinematical performance imparter, and the position in the three-dimensional virtual space of the character to which the kinematical performance is imparted is calculated by the position calculator. According to the first aspect, since the kinematical performance is imparted to a large number of the characters which form a group such that they follow respective of vertexes of the invisible three-dimensional polygon model, it is not required to prepare each motion for each character. Accordingly, processing is simplified and a state where the entire characters move as if they were one creature as a whole can be rendered.

In the first aspect, it is preferable that the kinematical performance imparter imparts an acceleration depending on a distance between the vertex of the three-dimensional polygon model and the character which is associated with the vertex as the kinematical performance. For example, when the distance is within a predetermined range, and the kinematical performance imparter calculates a force which is obtained by multiplying a predetermined constant and a position vector corresponding to the distance together as the acceleration, a state that a group of the characters having some fluctuation can be rendered. When the distance is out of a predetermined range, and the kinematical performance imparter imparts the acceleration as a predetermined fixed value, a state that a chaotic group of the characters having some tendency can be rendered. Both states can give an expression as if each character moved individually and naturally. Further, the position calculator may calculate a position of the character based on the acceleration according to Euler's motion equations. Moreover, in the first aspect, when the computer is further caused to function as a rotation angle calculator for calculating a rotation angle of the character per frame at the position which is calculated by the acceleration and a velocity of the character, natural grouped character controlling in a direction of each character which forms a group can be realized. At this time, when the rotation angle calculator calculates the rotation angle by decomposing the acceleration in a tangential acceleration and a normal acceleration, and calculating an angular velocity based on the normal acceleration and the velocity of the character, calculation processing is simplified as compared with conventional cases of solving motion equations regarding a rigid body and of using an inertial tensor. Accordingly, the number of the characters which forms a group may be increased and processing in the game apparatus becomes easy.

Further, in order to achieve the above object, according to a second aspect of the present invention, there is provided a computer-readable recording medium recording a program for controlling a movement of a group which is formed by a large number of characters in a three-dimensional virtual space, wherein said computer-readable recording medium records the program for causing a computer to function as: a model data imparter for imparting motion data of an invisible three-dimensional polygon model which operates in the three-dimensional virtual space; a kinematical performance imparter for imparting kinematical performance to each character which is associated with each vertex of the three-dimensional polygon model so as to follow the vertex; and a position calculator for calculating a position of the character in the three-dimensional virtual space. According to a third aspect of the present invention, there is provided a three-dimensional group controlling method for controlling a movement of a group which is formed by a large number of characters in a three-dimensional virtual space, comprising the steps of: imparting motion data of an invisible three-dimensional polygon model which operates in the three-dimensional virtual space; imparting kinematical performance to each character which is associated with each vertex of the three-dimensional polygon model so as to follow the vertex; and calculating a position of the character in the three-dimensional virtual space. And, according to a forth aspect of the present invention, there is provided a game apparatus for controlling a movement of a group which is formed by a large number of characters in a three-dimensional virtual space, comprising: a model data imparter for imparting motion data of an invisible three-dimensional polygon model which operates in the three-dimensional virtual space; a kinematical performance imparter for imparting kinematical performance to each character which is associated with each vertex of the three-dimensional polygon model so as to follow the vertex; and a position calculator for calculating a position of the character in the three-dimensional virtual space.

### BRIEF DESCRIPTION OF THE DRAWINGS

FIG. 1 is a schematic perspective view showing a connection aspect of a game apparatus for home use;

FIG. 2 is a plan view of an input appartus used in the game device for home use;

FIG. 3 is a block diagram showing a schematic configuration of a game apparatus main body;

FIG. 4 is a flowchart of a group controlling routine that a CPU of the game apparatus main body executes;

FIG. 5 is a flowchart of an initial setting processing subroutine showing details of step 102 in the group controlling routine;

FIG. 6 is a flowchart of a three-dimensional group controlling processing subroutine showing details of step 108 in the group controlling routine;

FIG. 7 is a flowchart of a fluctuation and swell (undulation) processing subroutine showing details of step 156 in the three-dimensional group controlling processing subroutine;

FIGS. 8A, 8B, 8C and 8D are explanatory diagrams showing kinematical performance of an agent character, FIG. 8A showing a relationship between a distance of an agent character to a target point and an acceleration of the agent character, FIG. 8B showing a relationship between a distance of the agent character to a target point and a velocity of the agent character, FIG. 8C showing a relationship between a velocity of the agent character and a simple oscillation, and FIG. 8D showing one example of an acceleration and the like which are predetermined in an embodiment;

FIG. 9 is an explanatory diagram showing a relationship between a locus of the target point and a locus of an agent character;

FIG. 10 is an explanatory diagram illustratively showing an acceleration between agent characters;

FIGS. 11A and 11B are explanatory diagrams showing a relationship between an agent character and Euler's motion equations, FIG. 11A showing a relationship among a position, a target point and an acceleration of the agent character, and FIG. 11B showing an absolute value of an acceleration which is predetermined for the agent character;

FIGS. 12A, 12B, 12C and 12D are explanatory diagrams showing direction control for an agent character, FIG. 12A showing a relationship between a direction vector and an acceleration of the agent character, FIG. 12B showing a relationship between a normal acceleration and a tangential acceleration of an acceleration of the agent character, FIG. 12C showing a rotation angle of the agent character, and FIG. 12D showing a relationship among a velocity, a normal acceleration and an angular velocity of the agent character in the rectangular coordinate system;

FIG. 13 is an explanatory diagram illustratively showing a moving direction of an agent character;

FIGS. 14A and 14B are explanatory diagrams illustratively showing a relationship between an imaginary model and an agent character in an initial setting state, FIG. 14A showing the imaginary model in a three-dimensional virtual space, and FIG. 14B showing the agent characters which are disposed to the imaginary model;

FIGS. 15A, 15B, 15C and 15D are explanatory diagrams illustratively showing states of agent characters when the imaginary model swings its arms, FIG. 15A showing a first state, FIG. 15B showing a second state, FIG. 15C showing a third state, and FIG. 15D showing a relationship between the imaginary model and the agent characters in the third state; and

FIGS. 16A and 16B are explanatory diagrams illustratively showing states of the agent characters which are viewed from different points of FIG. 15, FIG. 16A showing a state when movement of vertexes of arm portions of the imaginary model is set to be large, and FIG. 16B showing a state when movement of vertexes of arm portions of the imaginary model is set to be larger.

### DETAILED DESCRIPTION OF THE PREFERRED EMBODIMENTS

An embodiment where the present invention is applied to a video game will be explained with reference to the drawings.

(Structure)

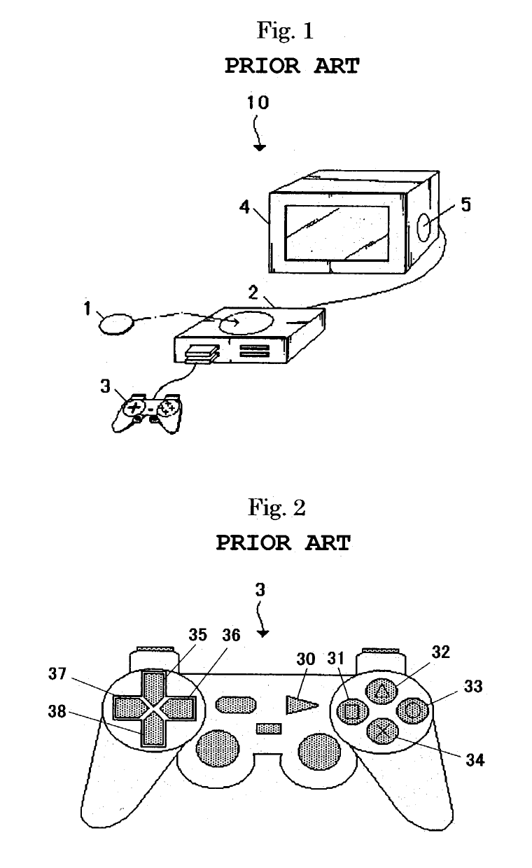

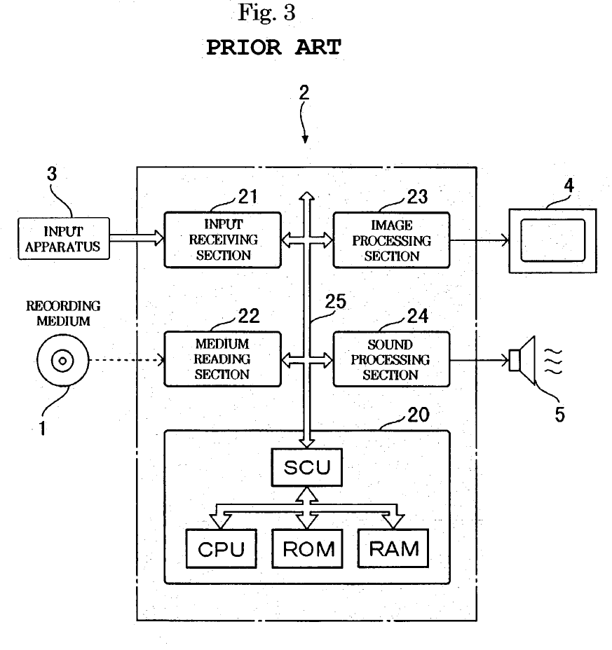

As shown in FIG. 1, in a video game apparatus for home use 10 where a video game according to this embodiment is performed, a game apparatus main body 2 is connected with a display such as a television monitor 4 housing a speaker 5 therein and with an input apparatus 3. The game apparatus main body 2 has a medium reading section (refer to FIG. 3) to which a recording medium 1 such as a CD-ROM or the like can be installed. A game program and game data recorded on the recording medium 1 is automatically loaded to a storing memory inside the game apparatus main body 2 by installing the recording medium to the medium reading section.

As shown in FIG. 2, various buttons such as a start button 30 for starting a game, a square button 31, a triangular button 32, a circular button 33, and an x shaped button 34 for operating a game character or for responding to a selection inquiry from the game apparatus main body 2, and a +shaped direction button set comprising a up (↑) button 35, a right (→) button 36, a left (←) button 37 and a down (↓) button 38, and the like are disposed at the input apparatus 3.

As shown in FIG. 3, the game apparatus main body 2 is provided with a CPU block 20 for implementing a control on the entire apparatus. The CPU block 20 is configured with a SCU (System Control Unit) for controlling data transmission among respective sections in the game apparatus main body 2, a CPU operating as a central processing unit at a high clock speed, a ROM in which a basic control operation of the game apparatus main body 2 is stored, a RAM serving as a work area for the CPU and temporarily storing game programs and various data recorded on the recording medium 1, and an internal bus for connecting these configurations.

An external bus 25 is connected to the SCU. The external bus 25 is connected to an input receiving section 21 which receives an input from the input apparatus 3 such as a controller pad or the like to transmit input information to the CPU block 20, a medium reading section 22, such as a CD-ROM drive or the like, which is provided with a unillustrated sub-CPU and reads the game program including the game data recorded on the recording medium 1 to transfer the read game program to the CPU block 20, an image processing section 23 which is provided with the CPU and a VRAM for performing graphic processing and performs light source processing and the like according to information fed from the CPU block 20 in order to implement rendering (graphically expressing) processing in a three-dimensional field, and a sound processing section 24 which is provided with the unillustrated sub-CPU and which processes sounds such as, for example, back music, fighting sounds and the like. Also, the input receiving section 21 is connected to the input apparatus 3, the image processing section 23 to the television monitor 4, and the sound processing section 24 to the speaker 5 housed in the television monitor 4.

(Operation)

Next, an operation of the video game apparatus for home use 10 will be explained mainly on the basis of the CPU of the CPU block 20 with reference to flowcharts. Incidentally, when the game apparatus main body 2 is supplied with a power source and the recording medium 1 is inserted therein, a group controlling routine is executed in order to form and render a group by a large number of agent characters (flying bodies such as birds or the like) in a three-dimensional virtual space as if the agent characters were one creature as a whole.

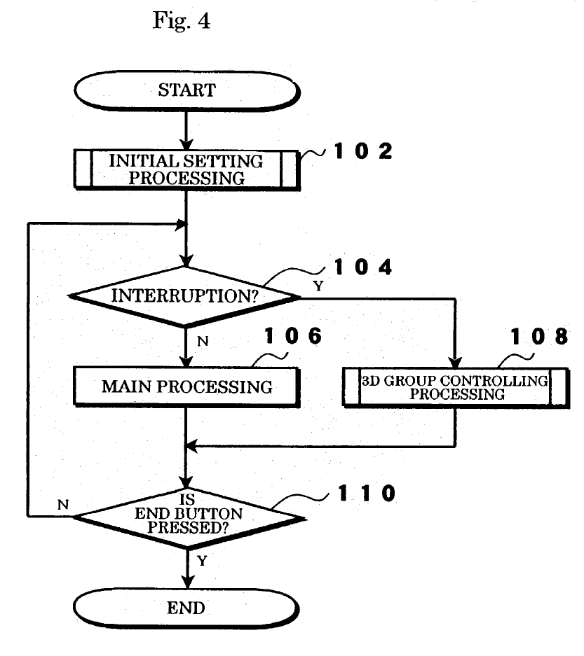

As shown in FIG. 4, in the group controlling routine, an initial setting processing subroutine for loading various data to the RAM and starting a motion of an imaginary model is performed firstly in step 102.

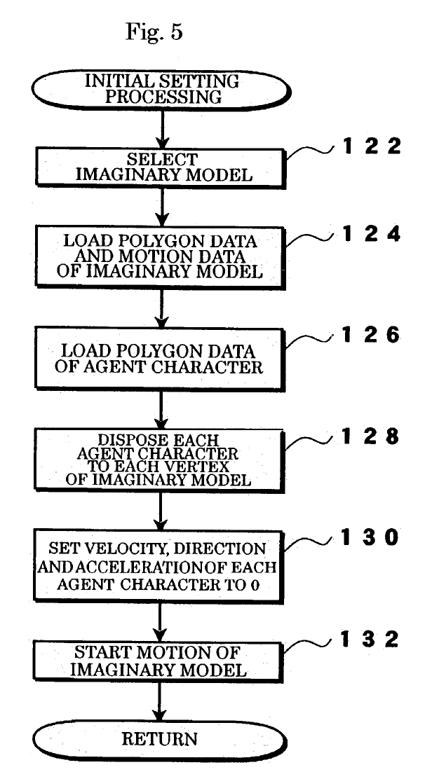

As shown in FIG. 5, in the initial setting processing subroutine, one imaginary model is (for example, randomly) selected among a plurality of imaginary models (three-dimensional polygon models) in step 122. The imaginary model is set to a size of about 10 m in each direction of x, y and z axes in the rectangular coordinate system (world coordinate system) in the three-dimensional virtual space. FIG. 14A shows one example of the imaginary model IM in an initial state. In the imaginary model IM, a state of the imaginary model IM which opens its arms is set as the initial state. Next, in step 124, polygon data and motion data of the selected imaginary model are loaded, and in step 126, polygon data of the agent character are loaded. In the next step 128, each agent character is disposed to each vertex of the imaginary model. Incidentally, each agent character which is disposed at each vertex of the imaginary model is associated with the vertex thereof. FIG. 14B shows a state that the agent character AC is disposed to the vertex of the imaginary model IM which is shown in FIG. 14A. In the present embodiment, a shape of the imaginary model IM and each vertex thereof are invisible (unexpressed on the television monitor 4), a distance among the vertexes in the three-dimensional virtual space is set to about 0.8 m, and the number of the vertexes is set to about 800 (the number of the agent characters is also set to about 800). Incidentally, various shapes can be applied to the shape of the imaginary model IM, and the number of the vertexes relates only to a surface of the imaginary model IM.

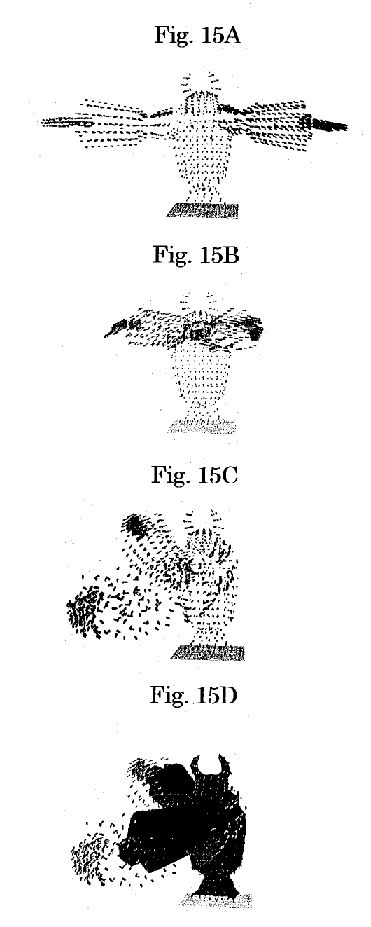

Next, after a velocity, a direction and an acceleration of each agent character AC are set to 0 in step 130, the motion of the imaginary model IM is started in step 132 and then the routine proceeds to step 104 as shown in FIG. 4. Each vertex of the imaginary model IM moves for each frame due to a motion reproduction or renewal of the imaginary model IM. Each agent character AC moves to each vertex of the moving imaginary model IM as a target point for each frame. That is, as shown in FIG. 15, in a motion that the imaginary model IM swings its arms according to the motion data from the initial state shown in FIG. 14A to a state shown in FIG. 15D, each agent character AC moves so as to follow each vertex coordinate of the imaginary model IM as shown in FIG. 15A, FIG. 15B and FIG. 15C from the initial state shown in FIG. 14B.

In step 104, determination is made about whether or not a vertical blanking interruption (Vsync) synchronizing with a vertical retrace line cycle of the television monitor 4, which is performed at one cycle per 1/60 sec. (16.6 milliseconds), is carried out. When the determination is negative, in the next step 106, main processing such as input processing for processing input information transferred from the input receiving section 21, sound processing for composing game effect sound in the sound processing section 24 or the like is performed, and the routine proceeds to step 110.

On the other hand, when the determination in step 104 is affirmative, a three-dimensional group controlling processing subroutine for rendering each agent character AC which moves so as to follow each vertex coordinate of the imaginary model IM is performed in step 108.

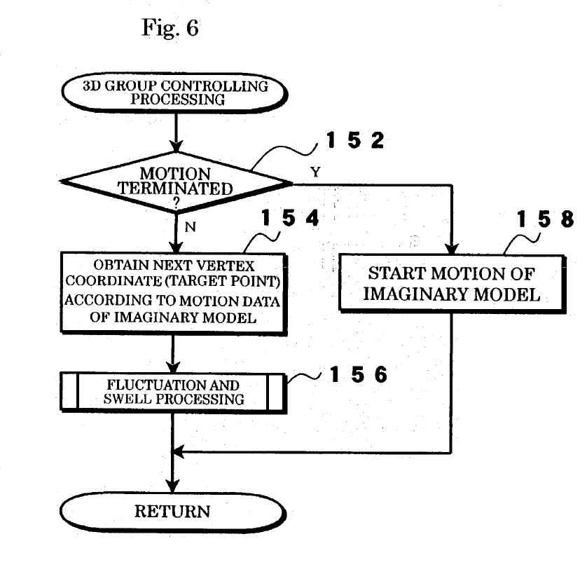

As shown in FIG. 6, in the three-dimensional group controlling processing subroutine, determination is made about whether or not the motion of the imaginary model IM is terminated by referring to a motion cursor (a motion counter) of the imaginary model IM in step 152. When the determination in step 152 is negative, next each vertex coordinate is obtained by the motion data of the imaginary model IM in step 154. In the next step 156, a fluctuation and swell processing subroutine for imparting kinematical performance to the agent character AC and for rendering the group which is formed by the agent characters in a fluctuating or swelling (undulating) state is performed.

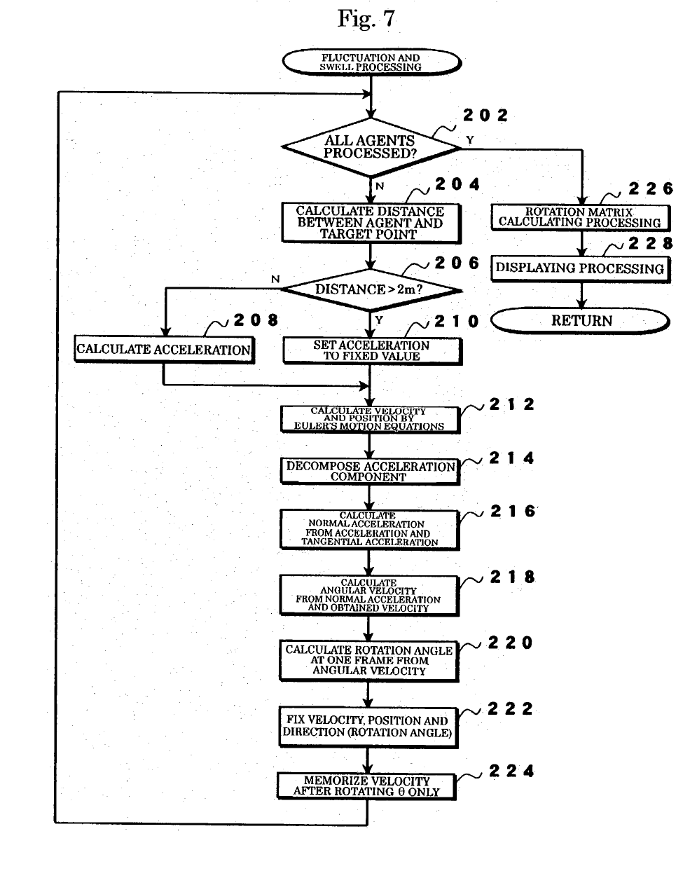

As shown in FIG. 7, in the fluctuation and swell processing subroutine, determination is made about whether or not the processing of the entire agent characters AC is terminated in step 202. When the determination is negative, the distance d between a subject agent character AC and target point thereof (the vertex coordinate of the imaginary model TM) in the three-dimensional virtual space is calculated in step 204. In the next step 206, determination is made about whether or not the distance d is over 2 m. When the determination in step 206 is negative, the acceleration of the subject agent character AC is calculated in step 208.

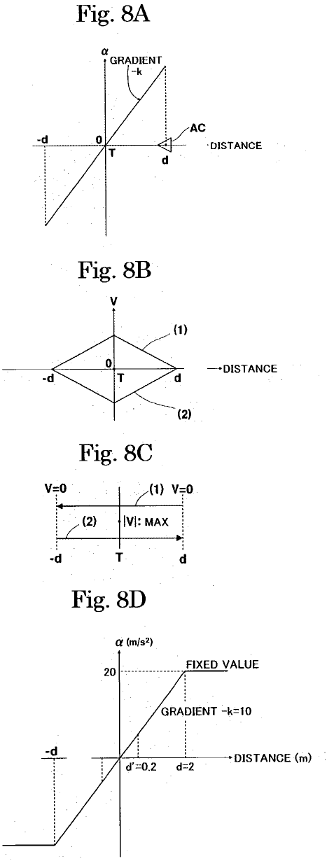

Here, a relationship between the distance d and an acceleration of the agent character AC will be explained. FIG. 8A shows the acceleration a of the agent character AC in a vertical axis and the distance d of the agent character AC from the target point T in a horizontal axis. The acceleration α of the agent character AC has a linear relationship between the distance d and a gradient −k in a predetermined range. The gradient −k is a predetermined constant. As shown in FIG. 8B, in a case of the agent character AC which exists at a position of the distance d from the target point T, the velocity V of the agent character AC increases gradually from the position of the distance d, and the acceleration a becomes 0 at the target point. T (refer to FIG. 8A). However, since the velocity V exists, the agent character AC moves to the same direction. Further, since the velocity V decreases due to a minus acceleration, when the agent character AC reaches a position of the distance −d from the target point T, the velocity V becomes 0 and the agent character AC repeats movement to the target point T in a reverse direction. Accordingly, as shown in FIG. 8C, the agent character AC repeats a simple oscillation between the distances d and −d relatively from the target point T. Therefore, when a position vector of the agent character AC from the target point T is set to R, the acceleration a of the agent character AC is obtained according to the following equation (1). Incidentally, in the equation (1), a mass m of the agent character AC is set to 1 in a motion equation which is expressed by F=mα.

$$α = \frac{{ⅆ}^{2} R}{ⅆ {t}^{2}} = - kR \qquad ( 1 )$$

As shown in FIG. 8D, in actual processing, the range of d, to which the equation (1) is applied, is set from −2(m) to 2(m) (−2≦d≦2), the acceleration α at d=±2(m) is set to ±20 (m/s²) respectively, and the gradient −k is set to about −10. In a range that the distance d exceeds ±2 (m) (d>2, −d<−2), the acceleration a is set to a fixed value (±20 M/s²).

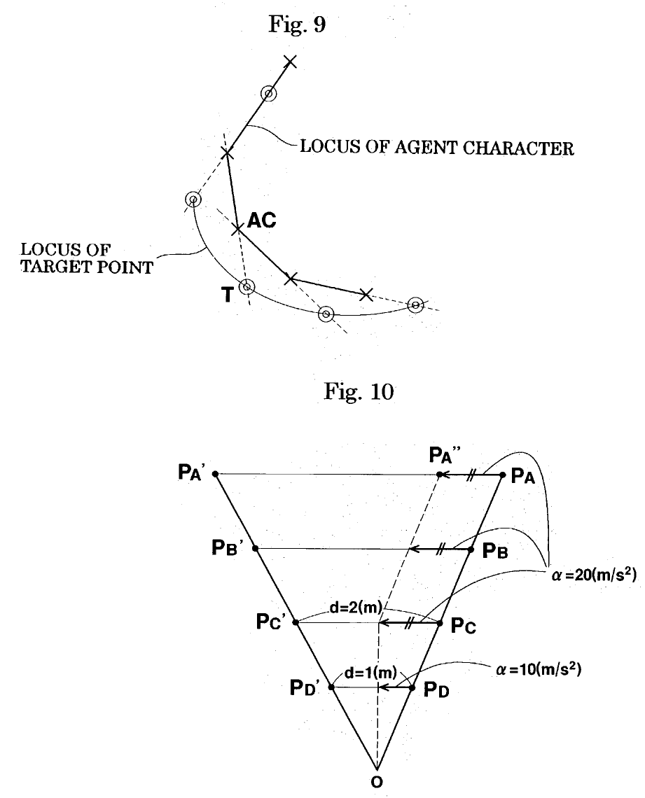

On the other hand, when the determination in step 206 is affirmative, the acceleration α of the subject agent character AC is set to the fixed value (20 m/s²) in step 210. When the distance d exceeds 2(m), a moving amount (acceleration) at a vertex of the imaginary model IM becomes large. However, since the acceleration a of the agent character AC is set to the fixed value, the kinematical performance of the agent character AC drops and the agent character AC can not catch up with the target point T. In a case that the agent character AC can always catch up with the target point T, since regular space between the agent character AC and the target point T is maintained (that is, the agent character AC is always disposed to the vertex of the imaginary model IM), the motion is not interesting. In order to produce an appropriate delay in the agent character AC to follow the target point T (at the position of last vertical blanking interruption time), as shown in FIG. 9, it is preferable that the acceleration of the agent character AC is set to about 50% compared with the acceleration of the target point T. From such a viewpoint, when the distanced exceeds 2 m, the acceleration α of the subject agent character AC is set to the fixed value of 20 m/s². That is, in a case of a motion that the imaginary model IM swings its arms, the target point of a fingertip of the imaginary model IM becomes the maximum moving point. When the maximum acceleration of the fingertip at this time is assumed as 40 m/s², 50% of the maximum acceleration, that is 20 m/s², is set as the fixed value in FIG. 8D. In a further detailed explanation, as shown in FIG. 10, in a case that the agent characters AC_{A} and AC_{B} are positioned at the points P_{A} and P_{B} in a certain frame and move toward the target points P_{A}′ and P_{B}′ which are positioned at a distance of 2 m or more, since the accelerations a of both the agent characters AC_{A} and AC_{B} are the same (20 m/s²) and the agent characters AC_{A} and AC_{B} move the same distance; however, the agent characters AC_{A} and AC_{B} do not reach the positions of the target points P_{A}′ and P_{B}′. Further, in order not to reach the positions of the target points P_{A}′ and P_{B}′, the maximum velocity of the agent characters AC is also limited (as one example, 10 m/s). Incidentally, as apparent from FIGS. 8D and 10, the acceleration a of the agent character AC_{C} whose distance d to the target point P_{C}′ is just 2 m is 20 m/s², and the acceleration a of the agent character AC_{D} whose distance d to the target point P_{D}′ is lm is 10 m/s². By repeating such states which are the same as the agent characters AC_{A} and AC_{B}, different amounts of lags between the-agent characters AC_{A}, AC_{B}, AC_{C} and the target points T are respectively accumulated. As a result, the expression does not become regular like an expression where the agent characters always position near the vertexes. The larger movement at the vertexes of the imaginary model IM is, the greater the lags are. Therefore, a state that the imaginary model IM lost its shape is expressed (refer to FIG. 15C).

In the next step 212, according to the following equation (2) that expresses Euler's motion equations by using velocity V₀ and position P₀ which are last velocity and position before obtaining the acceleration α (last vertical blanking interruption time), the current velocity V₁ and position P₁ of the subject agent character AC are calculated. Incidentally, in the equation (2), Δt expresses a time (1/60 seconds) from the last vertical blanking interruption to the recent vertical blanking interruption, and an absolute value of the acceleration a is a fixed value which is given as an external parameter.

$$\begin{matrix}{V}_{1} = {V}_{0} + α \cdot Δ t \\ {P}_{1} = {P}_{0} + {V}_{0} \cdot Δ t + \frac{1}{2} α \cdot Δ {t}^{2}\end{matrix} \} \qquad ( 2 )$$

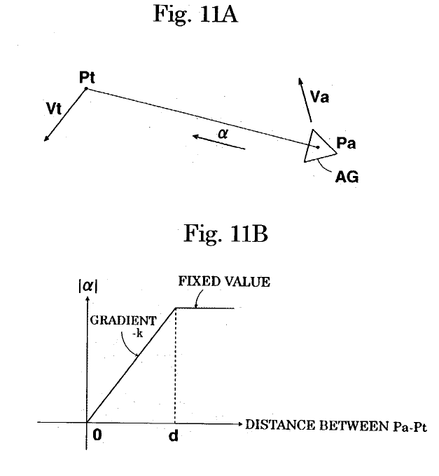

That is, by assuming that, when the target point is moving at Vt and positions at a point Pt, the agent character AC which moves at a velocity Va and which exists at a position Pa generates the acceleration a as shown in FIG. 11A, and when the distance d between Pa−Pt is larger than 2 m as shown in FIG. 11B, the absolute value of the acceleration a is set to the fixed value to restrain-or damp the acceleration α (the kinematical performance drops), thereby the agent character AC can not catch up with the target point Pt. However, at this stage, the direction of the subject agent character AC has not yet been taken into account and the agent character AC is considered as a particle without its direction. If the direction of the velocity Va is expressed by utilizing the Euler's motion equations as they are, an instant change to the opposed direction is not expressed naturally since the agent character AC has also the direction. This is why it is necessary to express a state that the direction is changed gradually. In this embodiment, in order to change the direction of the agent character AC for each vertical blanking interruption, a particle control having a direction which consists of particle control plus direction control for the subject agent character AC is performed in the following steps 214 to 224.

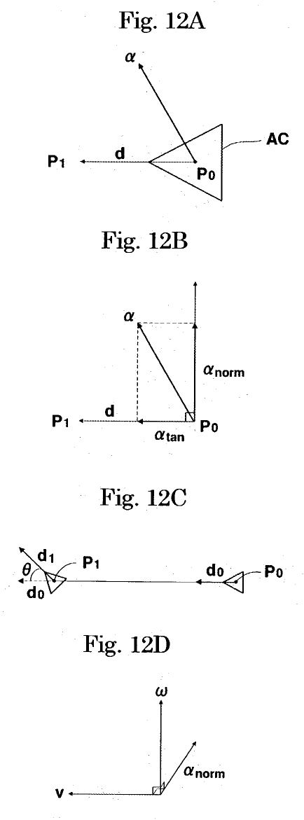

In step 214, the acceleration α is decomposed into a tangential acceleration and a normal acceleration. That is, as shown in FIG. 12A, when assuming that the acceleration a is added to the agent character AC which is moving in a direction of a direction vector d, the acceleration α that acts on the agent character AC is decomposed into the tangential acceleration αₜₐₙ which expresses a direction component of the direction vector d and the normal acceleration Δₙₒᵣₘ which is perpendicular to the tangential acceleration αₜₐₙ as shown in FIG. 12B. Incidentally, the direction vector is a unit vector whose degree of magnitude (scalar) has no meaning, and a vector (x, y, z) whose direction only has meaning. The acceleration α, the tangential acceleration at αₜₐₙ and the normal acceleration αₙₒᵣₘ have a relationship of α=αₜₐₙ+αₙₒᵣₘ. With regard to a component of the tangential acceleration αₜₐₙ, a position and a velocity can be obtained by utilizing the above-described equation (2).

In the next step 216, the normal acceleration αₙₒᵣₘ is calculated based on the acceleration a and the tangential acceleration αₜₐₙ (αₙₒᵣₘ=α−αₜₐₙ). As a result, a new position of the subject agent character AC is determined. At this time, the latest velocity V₁ which is obtained according to the equation (2) is used for the magnitude (scalar value) but not for the direction. That is, as shown in FIG. 12C, when the subject agent character AC moves from the point P₀ to the point P₁, the latest velocity V₁ is rotated at 0° simultaneously.

Thus, in step 218, an angular velocity ω (rad/s) is calculated based on the normal acceleration and the velocity of the subject agent character AC. As shown in FIG. 12D, when the velocity v is perpendicular to the normal acceleration αhd norm, a rotation axis is formed in a direction which is perpendicular to the velocity v and the normal acceleration αₙₒᵣₘ. A length of the rotation axis is the angular velocity ω. This relationship is expressed by the following equation (3) Incidentally, in the equation (3), “x” expresses an outer product and the velocity v is the latest velocity V₁.

αₙₒᵣₘ=ω×v (3)

Since the equation (3) uses the outer product, the angular velocity ω can not be calculated easily as αₙₒᵣₘ/v. For this reason, as shown in the following equation (4), the angular velocity ω is calculated by utilizing an equation for a triple product of the vector. Incidentally, since the velocity v and the rotation axis form 90°, an inter product of ω and v becomes 0.

$$\begin{matrix}{α}_{norm} \times v = ( ω \times v ) \times v \\ = ( ω \cdot v ) v - ( v \cdot v ) ω \\ = 0 v - {\vert v \vert}^{2} ω \\ ∴ ω = - \frac{1}{{\vert v \vert}^{2}} ( {α}_{norm} \times v ) \end{matrix} \qquad ( 4 )$$

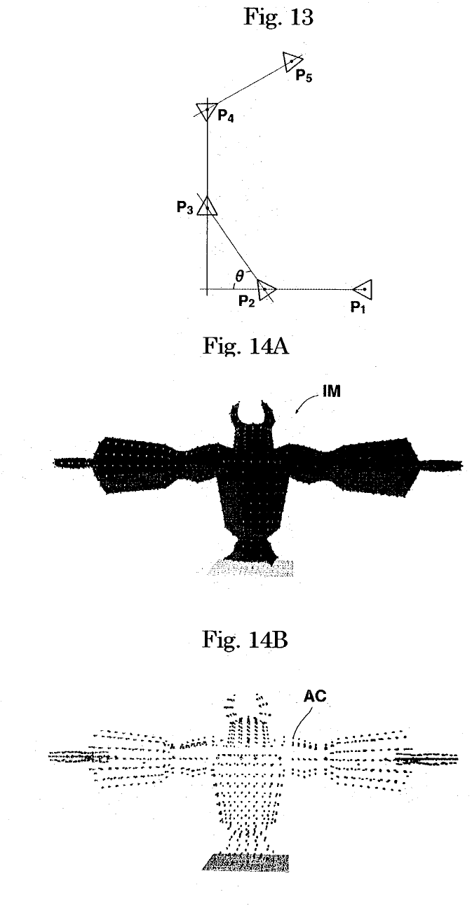

Next, in step 220, based on the angular velocity ω, a rotation angle θ of the subject agent character AC at one frame is calculated as θ=ωΔt. In the next step 222, since the velocity (the scalar value), the position and the direction (the rotation angle θ) of the subject agent character AC are fixed, the position and the velocity of the subject agent character AC in a state that they are rotated only by the rotation angle θ are memorized in the RAM in step 224, and the subroutine returns to step 202. Namely, as shown in FIG. 13, in order to use in the next frame, the latest velocity V₁ which is rotated only by the rotation angle θ is set as the current velocity.

Incidentally, in the above particle control having a direction, even when αₙₒᵣₘ is 0 in step 216, since the motion of the imaginary model IM is continuously performed and each vertex moves, decomposing processing for the components of the acceleration in step 214 is always performed (A flag control is not performed during the rotation of the subject agent character AC.). Further, even when the latest velocity V₁ of the subject agent character AC becomes minus and then the subject agent character AC returns, the angular velocity ω can be calculated according to the equations (3) and (4) (The flag control is not performed.).

On the other hand, when the determination in step 202 is affirmative, in order to update the velocity, the position and the direction of each agent character AC, a rotation calculation according to a matrix is performed in step 226. Such a rotation calculation technique according to the matrix is known by, for example, “Three-dimensional Computer Graphics”. (joint author: Eihachiro Nakamae and Tomoyuki Nishida), which is published by Kabushiki Kaisha Shokodo and the like. Thereby, as shown in FIG. 12C, for example, the agent character AC which positioned at P₀ at a last vertical blanking interruption time rotates only by the rotation angle θ at the updated position P₁.

In the next step 228, data calculated in step 226 are fed to the image processing section 23. Thereby, in the image processing section. 23, known rendering processing such as the light source processing and the like is performed, and then the image data are fed to the television monitor 4 for each vertical blanking interruption cycle, the fluctuation and swell processing subroutine as well as the three-dimensional group controlling processing subroutine are terminated, and the routine proceeds to step 110 in FIG. 4. On the television monitor 4, a large number of the agent characters AC are dynamically rendered for each vertical blanking interruption cycle as if they were one creature as a whole (refer to FIGS. 15A to 15C) Incidentally, when the determination in step 152 in FIG. 6 is affirmative, one of other motions (for example, a walking motion or the like) of the imaginary model IM is started in step 158, the three-dimensional group controlling processing subroutine is terminated, and the routine proceeds to step 110 in FIG. 4.

In step 110, determination is made about whether or not a predetermined button for terminating the game is pressed in step 106. When the determination is negative, the routine returns to step 104, and when the determination is affirmative, the group controlling routine is terminated.

(Effects and the Like)

Next, effects and the like of the video game in this embodiment will be explained.

In this embodiment, the three-dimensional polygon model (the imaginary model IM) is prepared (step 124)., and each agent character is imparted the kinematical performance (the acceleration α) according to the equation (1) so as to follow each vertex of the imaginary model IM (steps 208 and 210). Thereby, a group form of the agent characters having some fluctuation and a chaotic group form of the agent characters having some tendency (described later in detail) are realized at the same time. And the motion is imparted to the imaginary model IM that the agent characters follow (steps 132 and 158). Thereby, a state that the group of the agent characters move as if it was one creature as a whole is rendered (refer to FIG. 15).

At that time, the kinematical performance of each agent character is controlled appropriately such that each agent character moves to the position which does not exactly correspond to the position of each vertex coordinate of the imaginary model IM (step 208). Thereby, the group form having fluctuation to some degree is rendered. That is, as shown in FIGS. 15A to 15C, the motion (the moving amount) of each vertex is small at a body portion of the imaginary model IM. However, since a time lag occurs at a time of starting a movement of each vertex of the imaginary model IM, the distance d of each agent character which follows each vertex of the body portion as the target point T causes a subtle difference. Since the acceleration α is imparted as the kinematical performance according to the equation (1) by the different distance d, each agent character is disposed at a space which differs from the distance between the vertexes of the body portion, so that the group as a whole looks fluctuating. For this reason, the agent characters at the body portion do not look that they move the same distance uniformly but look that the move separately and naturally as if each of them had each of individualities. Based upon the example shown in FIG. 8D, Applicant confirmed that the fluctuation of the agent character AC remarkably appeared especially when the distance d of the agent character AC from the target point T was set to be within ±0.2(m) among the range of −2(m)≦distance d≦2(m).

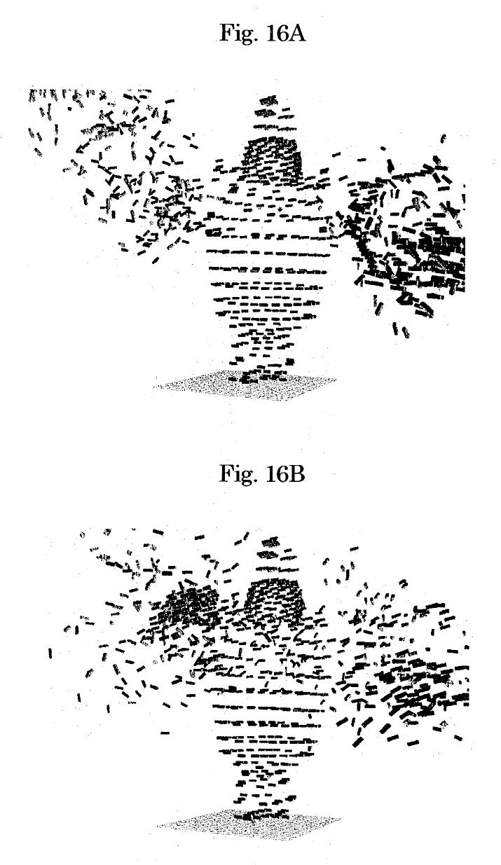

On the other hand, when the kinematical performance of each agent character is further restrained, the agent characters hardly remain the shape of the imaginary model IM. That is, arm portions of the imaginary model IM move largely, and the acceleration α of the agent character is set to the fixed value (eg. 20 m/s²). When the kinematical performance is damped by setting this fixed value smaller, as shown in FIG. 16B, the agent characters of the arm portions can not follow the target points and the group as a whole almost falls into a chaotic state. However, the chaotic state such as the Brownian motion is merely an entire chaotic state and one (a player) does not see any visual interesting about the group. In this embodiment, since each agent character which is controlled at the low kinematical performance follows each vertex of the imaginary model (step 210) although the group form of the agent characters which follow the target points T imperfectly can not be recognized clearly, a chaotic distribution having some tendency (a somehow recognizable distribution which forms the arm portions) occurs as the motion of the entire agent characters of the arm portions (the motion like a large undulation is rendered dynamically). Therefore, rendering with a great interesting motion can be realized (refer to FIGS. 15C and 16B).

Accordingly, in this embodiment, by imparting the kinematical performance shown in FIG. 8D to each agent character AC, the moving amount of each vertex coordinate of the imaginary model IM becomes larger, a lag between each agent character AC and the imaginary model IM occurs and the chaotic distribution having some tendency can be obtained. In contrast, the smaller the moving amount is, the smaller the lag is, and the distribution having some fluctuation can be obtained.

Further, in this embodiment, the direction of the agent character is set by the particle control having a direction which consists of the particle control for each agent character AC as a particle plus the simple direction control (steps 214 to 224). Accordingly, compared with cases of solving the Euler's motion equations regarding a rigid body and using a inertial tensor, the rigid body can be controlled by a relatively light calculation burden and the agent characters exceeding hundreds or a thousand can be processed in a real time with performance of the present game apparatus for home use for each vertical blanking interruption cycle. Furthermore, since a division of a simple force (Because the mass of the agent character is set to 1, the force means the same as the acceleration.) is merely carried out mathematically, the calculation becomes easy. Therefore, in this embodiment, group controlling where each agent character in the group which is formed by a large number of the agent characters in the three-dimensional virtual space naturally move to each direction can be realized.

Furthermore, in this embodiment, the invisible imaginary model TM is prepared and each agent character is disposed to each vertex coordinate thereof (steps 122 to 128). However, this does not mean that each agent character is calculated to disposed at a constant space according to an outer shape and a size of the imaginary model TM. By utilizing the invisible imaginary polygon model, a group as a whole can be controlled by a program like a usual polygon model. Since a space between each disposed agent character has been decided at the time of preparing the imaginary model, it is not necessary to calculate the equal space during displaying processing. Besides, in this embodiment, one motion of the imaginary model as a whole is basically reproduced. That is, since each agent character is disposed so as to follow each vertex coordinate of the imaginary model IM which is changed according to the motion, it is not necessary to prepare each motion for each agent character. Therefore, handling of the group as a whole becomes easy in programming. Moreover, the movement of each agent character which forms the group looks complicated, and rendering having variety can be obtained.

Besides, in this embodiment, an eye point can be moved into the body of the imaginary model IM when a player operates the input apparatus 3. The eye point is not allowed to enter into the polygon model in a common game and the like. Even if the eye point can enter into a polygon model, the circumference is surrounded by surfaces. In this embodiment, by entering the eye point into the imaginary model IM, a player can enjoy a world of 360° in which the eye point, namely, a player is surrounded by the agent characters.

Incidentally, in this embodiment, the example that one of other motions of the same imaginary model IM is started in step 158 was explained, however, the motion may be changed to a motion of other imaginary models, for example. With such a constitution, the game which a player does not lose interest can be obtained. In this case, according to various motions of the imaginary model IM, it is preferable that the fixed value in FIG. 8D is set to be about 1/2 of the motion which imparts the maximum acceleration.

Further, in this embodiment, the example of the flying body such as a bird or the like as an agent character was explained, but this invention is not limited to this example. The present invention can be applied to, for example, a school of fish or the like in water, or a fleet of spaceships in the cosmic space, or the like. In this case, the gradient −k shown in the equation (1), the distance d shown in FIG. 8D and the like may be changed.

Furthermore, in this embodiment, the example of the distance d and the acceleration α corresponding to the size of the imaginary model IM in the three-dimensional virtual space were shown, however, such values may, of course, be changed depending upon the size of the imaginary model IM.

Besides, in this embodiment, the example that the acceleration and the like of all the agent characters are calculated for each vertical blanking interruption cycle was shown, however, since the position of the agent character is not changed largely in case that the distance d is, for example, less than 1 m, the position may be processed in the same manner as the last position. By employing such processing, although remarkable fluctuation can not be rendered, but the number of the agent characters which forms the group can be increased further due to decreasing in a calculation burden.

Further, in this embodiment, in the medium reading section 22, the program is transferred to the RAM by reading the recording medium 1 on which the game program and the game data have been recorded. However, such a constitution may be employed in this invention that the medium reading section 22 is not provided and the game program is memorized in the ROM, so that the game program or the game data is read out from the ROM. Such a constitution can provide an exclusive game apparatus. Further, in this embodiment, the example that the CD-ROM is used as the recording medium was explained, however, a ROM cartridge, a mass storage disc, a magnet-optical disc or the like which is loaded to the RAM of the CPU block 20 may be applied as long as the game apparatus is equipped with a reading section for reading the medium.

Furthermore, in this embodiment, the example that the acceleration and the position of the agent character are calculated within the vertical blanking interruption time in order to execute calculation at a predetermined interval was shown, but the present invention may be implemented by timer interruption processing or even by main processing.

Besides, in this embodiment, the example of the Euler's motion equations in which the third term including Δt² is included when the position of the agent character is calculated according to the equation (2) was shown, however, the calculation of the third term may be omitted so that the computation burden of the CPU is reduced.

What is claimed is:

1. A program for controlling a movement of a group which is formed by a large number of characters in a three-dimensional virtual space, wherein a computer is caused to function as:
a model data imparter for imparting motion data of an invisible three-dimensional polygon model which operates in the three-dimensional virtual space;
a kinematical performance imparter for imparting kinematical performance to each character which is associated with each vertex of the three-dimensional polygon model so as to follow the vertex; and
a position calculator for calculating a position of the character in the three-dimensional virtual space.

2. A program according to claim 1, wherein the kinematical performance imparter imparts an acceleration depending on a distance between the vertex of the three-dimensional polygon model and the character which is associated with the vertex as the kinematical performance.

3. A program according to claim 2, wherein, when the distance is within a predetermined range, the kinematical performance imparter calculates a force which is obtained by multiplying a predetermined constant and a position vector corresponding to the distance together as the acceleration.

4. A program according to claim 2, wherein, when the distance is out of a predetermined range, the kinematical performance imparter imparts the acceleration as a predetermined fixed value.

5. A program according to claim 2, wherein the position calculator calculates a position of the character based on the acceleration according to Euler's motion equations.

6. A program according to claim 2, wherein the computer is further caused to function as a rotation angle calculator for calculating a rotation angle of the character per frame at the position which is calculated by the acceleration and a velocity of the character.

7. A program according to claim 6, wherein the rotation angle calculator calculates the rotation angle by decomposing the acceleration in a tangential acceleration and a normal acceleration, and calculating an angular velocity based on the normal acceleration and the velocity of the character.

8. A computer-readable recording medium recording a program for controlling a movement of a group which is formed by a large number of characters in a three-dimensional virtual space, wherein said computer-readable recording medium records the program for causing a computer to function as:
a model data imparter for imparting motion data of an invisible three-dimensional polygon model which operates in the three-dimensional virtual space;
a kinematical performance imparter for imparting kinematical performance to each character which is associated with each vertex of the three-dimensional polygon model so as to follow the vertex; and
a position calculator for calculating a position of the character in the three-dimensional virtual space.

9. A computer-readable recording medium according to claim 8, wherein the kinematical performance imparter imparts an acceleration depending on a distance between the vertex of the three-dimensional polygon model and the character which is associated with the vertex as the kinematical performance.

10. A computer-readable recording medium according to claim 9, wherein, when the distance is within a predetermined range, the kinematical performance imparter calculates a force which is obtained by multiplying a predetermined constant and a position vector corresponding to the distance together as the acceleration.

11. A computer-readable recording medium according to claim 9, wherein, when the distance is out of a predetermined range, the kinematical performance imparter imparts the acceleration as a predetermined fixed value.

12. A computer-readable recording medium according to claim 9, wherein the position calculator calculates a position of the character based on the acceleration according to Euler's motion equations.

13. A computer-readable recording medium according to claim 9, wherein the computer is further caused to function as a rotation angle calculator for calculating a rotation angle of the character per frame at the position calculated by the position calculator based on the acceleration and a velocity of the character.

14. A computer-readable recording medium according to claim 13, wherein the rotation angle calculator calculates the rotation angle by decomposing the acceleration in a tangential acceleration and a normal acceleration, and calculating an angular velocity based on the normal acceleration and the velocity of the character.

15. A three-dimensional group controlling method for controlling a movement of a group which is formed by a large number of characters in a three-dimensional virtual space, comprising the steps of:
imparting motion data of an invisible three-dimensional polygon model which operates in the three-dimensional virtual space;
imparting kinematical performance to each character which is associated with each vertex of the three-dimensional polygon model so as to follow the vertex; and
calculating a position of the character in the three-dimensional virtual space.

16. A three-dimensional group controlling method according to claim 15, wherein the kinematical performance is imparted as an acceleration depending on a distance between the vertex of the three-dimensional polygon model and the character which is associated with the vertex.

17. A three-dimensional group controlling method according to claim 16, further comprising the step of calculating a rotation angle of the character per frame at the position which is calculated by the acceleration and a velocity of the character.

18. A game apparatus for controlling a movement of a group which is formed by a large number of characters in a three-dimensional virtual space, comprising:
a model data imparter for imparting motion data of an invisible three-dimensional polygon model which operates in the three-dimensional virtual space;
a kinematical performance imparter for imparting kinematical performance to each character which is associated with each vertex of the three-dimensional polygon model so as to follow the vertex; and
a position calculator for calculating a position of the character in the three-dimensional virtual space.

19. A game apparatus according to claim 18, wherein the kinematical performance imparter imparts an acceleration depending on a distance between the vertex of the three-dimensional polygon model and the character which is associated with the vertex as the kinematical performance.

20. A game apparatus according to claim 19, further comprising a rotation angle calculator for calculating a rotation angle of the character per frame at the position which is calculated by the acceleration and a velocity of the character.
